(19) United States
(12) Patent Application Publication
(10) Pub. No.: US 2018/0346760 A1
(43) Pub. Date: Dec. 6, 2018

(54) COMPOSITION FOR MAKING HARD COATING LAYER

(71) Applicant: SK INNOVATION CO., LTD., Seoul (KR)

(72) Inventors: Won-Yeob KIM, Daejeon (KR); Hye-Jin KIM, Daejeon (KR); Ho-Chul YOON, Daejeon (KR); Young-June PARK, Seoul (KR)

(21) Appl. No.: 16/101,242

(22) Filed: Aug. 10, 2018

Related U.S. Application Data
(62) Division of application No. 14/809,514, filed on Jul. 27, 2015.

(30) Foreign Application Priority Data
Jul. 25, 2014 (KR) 10-2014-0094672

(51) Int. Cl. C09D 183/06; C08J 7/04; C08G 77/14

(52) U.S. Cl. CPC C09D 183/06; C08J 7/047; C08J 2367/02; C08J 2483/06; C08G 77/14

(57) ABSTRACT

A composition for forming a hard coating layer includes an epoxy siloxane resin having a weight average molecular weight in the range of 2,000 to 15,000 and a polydispersity index (PDI) in the range of 2.0 to 4.0, and thus may form a hard coating layer having significantly improved hardness as well as excellent flexibility such that bending deformation is minimized.

### CROSS-REFERENCE TO RELATED APPLICATION

This application is a division of U.S. patent application Ser. No. 14/809,514 filed on Jul. 27, 2015, which claims priority to and the benefit of Korean Patent Application No. 2014-0094672, filed on Jul. 25, 2014. The disclosure of each of the foregoing applications is incorporated herein by reference in its entirety.

### BACKGROUND

### 1. Field of the Invention

The present invention relates to a composition for forming a hard coating layer.

### 2. Discussion of Related Art

Recently, thin display devices using flat display devices such as liquid crystal display devices, organic light emitting diode display devices or the like have received much attention. Especially, these thin display devices are implemented in the form of a touch screen panel and are widely used in a variety of smart devices characterized by portability such as smart phones, tablets, PCs and a diversity of wearable devices.

These portable display devices based on a touch screen panel includes a window substrate for protecting displays on a display panel to protect a display panel from scratches or external shocks. In most cases, tempered glass for display is used as the window substrate. Tempered glass for display is thinner than general glass, but has high strength and scratch resistance.

However, a heavy weight of tempered glass is unsuitable for reducing the weight of portable devices. Further, tempered glass is difficult to implement unbreakable characteristics due to its vulnerability to external shocks. Tempered glass may only bend to a limited degree, and thus is unsuitable as a material for flexible displays which are bendable and foldable.

In recent, various researches on optical plastic substrates ensuring flexibility and impact resistance, and having strength or scratch resistance equal to those of tempered glass have been conducted. Generally, examples of the optical plastic substrates which are more flexible than tempered glass include polyethylene terephthalate (PET), polyethersulfone (PES), polyethylene naphthalate (PEN), polyacrylate (PAR), polycarbonate (PC), polyimide (PI), etc. However, these polymer plastic substrates exhibit insufficient physical properties of hardness and scratch resistance as compared to tempered glass used as a window substrate for protecting displays, and also has insufficient impact resistance. Accordingly, many attempts to complement the physical properties by coating these plastic substrates with a composite resin composition have been in progress.

In a general hard coating process, a composition including a resin having photocurable functional groups such as an acrylate group, an epoxy group or the like and a curing agent or a curing catalyst and a reactive additive is used. Especially, a composite resin having a high functional group may be used as a window substrate for protecting displays having improved hardness and scratch resistance when the optical plastic base material film is coated with the composite resin.

However, in the case of general photocurable composite resins having a high functional group of an acrylate or epoxy group, it is difficult to implement high hardness equal to that of tempered glass, and large bending deformation (curling) due to shrinkage occurs upon curing of the resin. Flexibility is also insufficient, and thus these resins are unsuitable as a window substrate for protecting displays to be applied to flexible displays.

A plastic substrate is disclosed in Korean Laid-open Patent Application No. 2013-74167.

### Patent Document

Korean Laid-open Patent Application No. 2013-74167

### SUMMARY OF THE INVENTION

The present invention is directed to providing a composition which may form a hard coating layer having significantly improved hardness.

The present invention is directed to providing a composition which may form a hard coating layer having excellent flexibility.

The present invention is directed to providing a base material having the hard coating layer.

According to an aspect of the present invention, there is provided a composition for forming a hard coating layer including an epoxy siloxane resin which has a weight average molecular weight in the range of 2,000 to 15,000 and a polydispersity index (PDI) in the range of 2.0 to 4.0.

The siloxane resin may have a weight average molecular weight in the range of 5,000 to 15,000.

The siloxane resin may have an epoxy equivalent weight in the range of 3.0 to 6.3 mmol/g.

The siloxane resin may be prepared by a hydrolysis and condensation reaction of an alkoxysilane represented by the following Formula 1:

R¹ₙSi(OR²)₄₋ₙ [Formula 1]

(where R¹ is an epoxy cycloalkyl group having 3 to 6 carbon atoms, or a linear or branched alkyl group having 1 to 6 carbon atoms and substituted with an oxiranyl group, and may be interrupted by oxygen, R² is a linear or branched alkyl group having 1 to 7 carbon atoms, and n is an integer in the range of 1 to 3)

The alkoxysilane represented by Formula 1 may be at least one type selected from the group consisting of 2-(3,4-epoxycyclohexyl)ethyltrimethoxysilane, 2-(3,4-epoxycyclohexyl)ethyl triethoxysilane and 3-glycidoxypropyltrimethoxysilane.

The siloxane resin may be prepared by a hydrolysis and condensation reaction of the alkoxysilane represented by Formula 1 and an alkoxysilane represented by the following Formula 2:

R³ₘSi(OR⁴)₄₋ₘ [Formula 2]

(where, R³ includes at least one functional group selected from the group consisting of an alkyl group having 1 to 20 carbon atoms, a cycloalkyl group having 3 to 8 carbon atoms, an alkenyl group having 3 to 20 carbon atoms, an alkynyl group having 2 to 20 carbon atoms, and an aryl group having 6 to 20 carbon atoms, acrylic group, methacrylic group, halogen group, amino group, mercapto group, ether group, ester group, carbonyl group, carboxyl group, vinyl group, nitro group, sulfone group and alkyd group, R⁴ is a linear or branched alkyl group having 1 to 7 carbon atoms, and m is an integer in the range of 0 to 3)

The composition for forming a hard coating layer may further include a polymerization initiator at 0.1 to 10 parts by weight and a solvent at 20 to 70 parts by weight based on 100 parts by weight of the epoxy siloxane resin.

According to another aspect of the present invention, there is provided a hard coating film including a base material of which at least one surface has a hard coating layer formed of the above-described composition.

The base material may be made from at least one resin selected from the group consisting of a polyester-based resin, a cellulose-based resin, a polycarbonate-based resin, an acrylic resin, a styrene-based resin, a polyolefin-based resin, a polyimide-based resin, a polyether sulfone-based resin and a sulfone-based resin.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic cross-sectional view of a base material including a hard coating layer formed of a composition for forming a hard coating layer according to an embodiment of the present invention;

FIG. 2 schematically illustrates an embodiment of performing a bending test for a base material including a hard coating layer formed of a composition for forming a hard coating layer according to the embodiment of the present invention; and

FIG. 3 schematically illustrates an embodiment of performing a bending test for a base material including a hard coating layer formed of a composition for forming a hard coating layer according to the embodiment of the present invention.

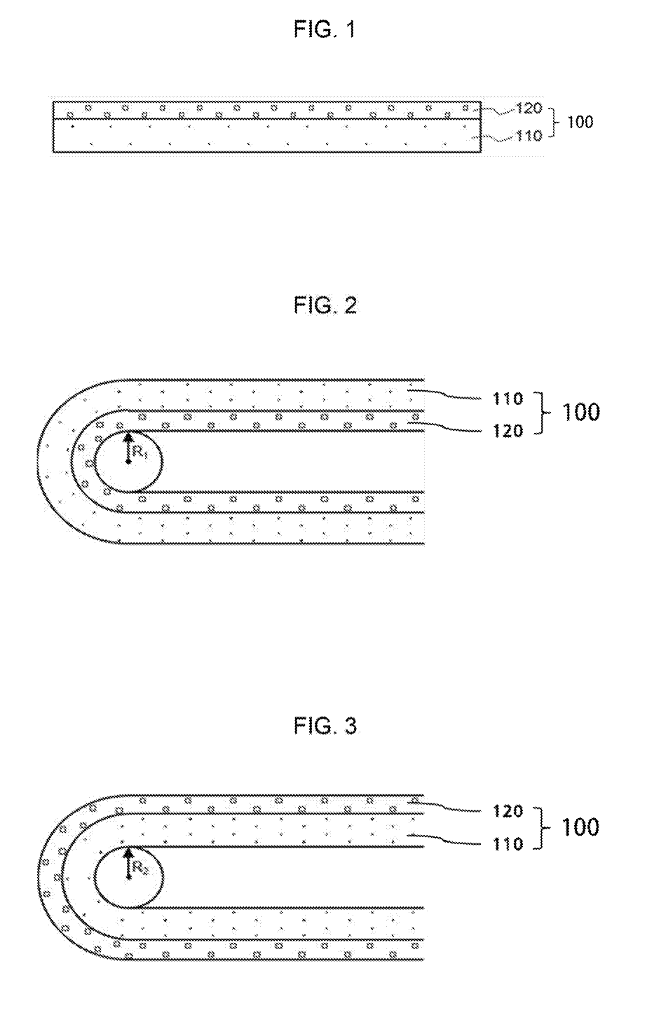

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

The present invention relates to a composition for forming a hard coating layer, which may form a hard coating layer having significantly improved hardness as well as excellent flexibility such that bending deformation is minimized.

Hereinafter, the present invention will be described in detail.

Composition for Forming Hard Coating Layer

The composition for forming a hard coating layer according to an embodiment of the present invention includes an epoxy siloxane resin having a weight average molecular weight in the range of 2,000 to 15,000 and a polydispersity index (PDI) in the range of 2.0 to 4.0.

In the present specification, the epoxy siloxane resin refers to a siloxane resin having an epoxy group, and the epoxy group may be an alicyclic epoxy group, an aliphatic epoxy group, an aromatic epoxy group or a mixture thereof.

Since the epoxy siloxane resin having a weight average molecular weight and a polydispersity index in the specific range is used in the composition for forming a hard coating layer according to the embodiment of the present invention, the hardness of the hard coating layer may be significantly improved. Furthermore, flexibility is considerably enhanced such that bend modification may be suppressed.

The epoxy siloxane resin has a weight average molecular weight in the range of 2,000 to 15,000. When the weight average molecular weight is less than 2,000, the desired hardness of the hard coating layer is not implemented, and ductility is exhibited. When the weight average molecular weight is more than 15,000, a desired physical property, that is, high hardness of the hard coating layer may be obtained, but the processability which is required in film processing is degraded. In consideration of the hardness and processability of the hard coating layer, the weight average molecular weight may be preferably in the range of 5,000 to 15,000.

The epoxy siloxane resin has a polydispersity index (PDI) in the range of 2.0 to 4.0. When the polydispersity index is less than 2.0, two physical properties of both hardness and ductility of the hard coating layer are difficult to be satisfied. When the polydispersity index is more than 4.0, the physical property of ductility is excessively exhibited.

The epoxy equivalent weight of the epoxy siloxane resin is not particularly limited, and for example, may be in the range of 3.0 to 6.3 mmol/g. When the epoxy equivalent weight is in the above-described range, a compact cross-linking network may be formed, and hardness may be notably improved.

The epoxy siloxane resin according to the embodiment of the present invention may be prepared by the hydrolysis and condensation reaction of an independent alkoxysilane having an epoxy group, or may be prepared by the hydrolysis and condensation reaction of an alkoxysilane having an epoxy group and a different type of an alkoxysilane, in the presence of water.

The following Reaction Formulas 1 to 3 schematically show the hydrolysis and condensation reaction of the alkoxysilane in the presence of water and a catalyst.

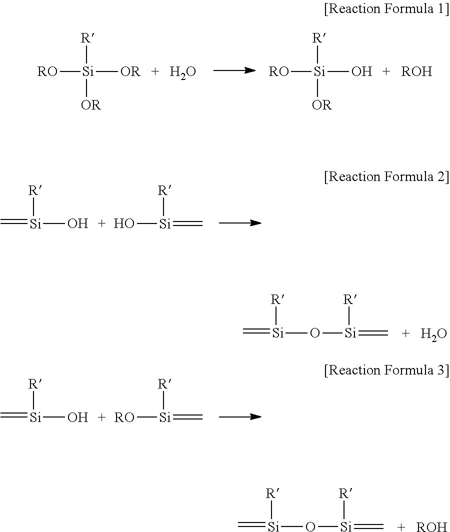

In Reaction Formulas 1 to 3, R may be a linear or branched alkyl group having 1 to 7 carbon atoms, and R′ may include at least one functional group selected from the group consisting of a linear or branched alkyl group having 1 to 20 carbon atoms, a cycloalkyl group having 3 to 8 carbon atoms, an alkenyl group having 3 to 20 carbon atoms, an alkynyl group having 2 to 20 carbon atoms, and an aryl group, acrylic group, methacrylic group, halogen group, amino group, mercapto group, ether group, ester group, carbonyl group, carboxyl group, vinyl group, nitro group, sulfone group and alkyd group having 6 to 20 carbon atoms, which include an epoxy group.

Reaction Formula 1 shows an alkoxy group of an alkoxysilane which is a starting material is hydrolyzed by water to form a hydroxyl group. As may be seen from Reaction Formula 2 or 3, such formed hydroxyl group forms a siloxane bond through the condensation reaction with a hydroxyl group or an alkoxy group of the other silane. Accordingly, when the speed of the reaction is adjusted, the weight average molecular weight and polydispersity index (PDI) of a finally formed siloxane compound may be adjusted. The reaction temperature, the amount and type of a catalyst, a solvent and the like may also be a main factor.

A catalyst is used in order to prepare the epoxy siloxane resin having a weight average molecular weight in the range of 2,000 to 15,000 and a polydispersity index in the range of 2.0 to 4.0 through the reaction formula. Examples of the catalyst which may be used include an acid catalyst such as hydrochloric acid, acetic acid, hydrogen fluoride, nitric acid, sulfuric acid, chlorosulfonic acid, iodic acid, pyrophosphoric acid and the like; a base catalyst such as ammonia, potassium hydroxide, sodium hydroxide, barium hydroxide, an imidazole, an n-butylamine, a di-n-butylamine, a tri-n-butylamine, an ammonium perchlorate, a tetramethyl ammonium hydroxide and the like; an ion exchange resin such as Amberite IRA-400, IRA-67 and the like; and mixtures thereof.

Although the amount of the catalyst is not particularly limited, the acid catalyst or the base catalyst may be added at about 0.0001 to 0.01 part by weight based on about 100 parts by weight of the alkoxysilane, and the ion exchange resin may be added at about 1 to 10 parts by weight, but the present invention is not limited thereto.

The hydrolysis and condensation reaction may be performed at room temperature for about 12 hours to about 7 days with stirring, and may be stirred at about 60 to 100° C. for about 2 to 72 hours to promote the reaction, but is not limited thereto.

As may be seen from Reaction Formulas 1 to 3, when the reaction initiates, an alcohol and water are generated as a by-product. When these by-products are removed, an inverse reaction may be reduced while a forward reaction may be induced, and thereby the speed of the reaction may be adjusted. Moreover, when the reaction is complete, the alcohol and water remaining in the siloxane resin may be removed by being subject to conditions of a temperature in the range of about 60 to 100° C. for about 10 to 60 minutes under reduced pressure, but the present invention is not limited thereto.

The alkoxysilane having an epoxy group used to prepare the epoxy siloxane resin according to the embodiment of the present invention may be exemplified by the following Formula 1:

R¹ₙSi(OR²)₄₋ₙ [Formula 1]

(where R¹ is an epoxy cycloalkyl group having 3 to 6 carbon atoms, or a linear or branched alkyl group having 1 to 6 carbon atoms and substituted with an oxiranyl group, and R′ may be interrupted by oxygen, R² is a linear or branched alkyl group having 1 to 7 carbon atoms, and n is an integer in the range of 1 to 3)

The alkoxysilane represented by Formula 1 is not particularly limited, and for example, may include 2-(3,4-epoxycyclohexyl)ethyltrimethoxysilane, 2-(3,4-epoxycyclohexyl)ethyltriethoxysilane, 3-glycidoxypropyltrimethoxysilane, etc. One or mixtures of two or more types thereof may be used.

According to the embodiment of the present invention, the epoxy siloxane resin may be prepared by an independent alkoxysilane having an epoxy group, but may also be prepared by the hydrolysis and condensation reaction of the alkoxysilane having an epoxy group and a different type of the alkoxysilane, and is not limited thereto.

The different type of the alkoxysilane may be at least one selected from alkoxysilanes represented by the following Formula 2:

R³ₘSi(OR⁴)₄₋ₘ [Formula 2]

(where, R³ may include at least one functional group selected from the group consisting of an alkyl group having 1 to 20 carbon atoms, a cycloalkyl group having 3 to 8 carbon atoms, an alkenyl group having 3 to 20 carbon atoms, an alkynyl group having 2 to 20 carbon atoms, and an aryl group having 6 to 20 carbon atoms, acrylic group, methacrylic group, halogen group, amino group, mercapto group, ether group, ester group, carbonyl group, carboxyl group, vinyl group, nitro group, sulfone group and alkyd group, R⁴ is a linear or branched alkyl group having 1 to 7 carbon atoms, and m is an integer in the range of 0 to 3)

The alkoxysilane represented by Formula 2 is not particularly limited, and for example, may include tetramethoxysilane, tetraethoxysilane, methyltrimethoxysilane, methyltri ethoxysilane, methyltripropoxysilane, dimethyldimethoxysilane, dimethyldiethoxysilane, phenyltrimethoxysilane, phenyltriethoxysilane, diphenyldimethoxysilane, diphenyldi ethoxysilane, triphenylmethoxysilane, triphenylethoxysilane, ethyltriethoxysilane, propylethyltrimethoxysilane, vinyltrimethoxysilane, vinyltriethoxysilane, vinyltripropoxysilane, N-(3-acryloxy-2-hydroxypropyl)-3-aminopropyltrimethoxysilane, N-3-acryloxy-2-hydroxypropyl)-3-aminopropyltriethoxysilane, N-(3-acryloxy-2-hydroxypropyl)-3-aminopropyltripropoxysilane, 3-acryloxypropyl methyl bis(trimethoxy)silane, 3-acryloxypropyl trimethoxysilane, 3-acryloxypropyl triethoxysilane, 3-acryloxypropyl tripropoxysilane, 3-(meth)acryloxypropyl trimethoxysilane, 3-(meth)acryloxypropyl triethoxysilane, 3-(meth)acryloxypropyl tripropoxysilane, N-(aminoethyl-3-aminopropyl) trimethoxysilane, N-(2-aminoethyl-3-aminopropyl) triethoxysilane, 3-aminopropyltrimethoxysilane, 3-aminopropyltriethoxysilane, chloropropyltrimethoxysilane, chloropropyltriethoxysilane, heptadecafluoro-decyl trimethoxysilane, etc. One or mixtures of two or more types thereof may be used.

The composition for forming a hard coating layer according to the embodiment of the present invention may further include an acrylate oligomer to improve hardness.

The acrylate oligomer according to the embodiment of the present invention is not particularly limited, and may include a polyester acrylate, urethane acrylate, epoxy acrylate, polyether acrylate oligomer, etc. Preferably, the urethane acrylate oligomer may be used.

Hereinafter, the case of the urethane acrylate oligomer will be described in detail, but the present invention is not limited thereto.

The urethane acrylate oligomer according to the embodiment of the present invention may have 6 to 9 functional groups. When the number of the functional groups is less than 6, the effect of improving hardness is low, and when the number of the functional groups is more than 9, excellent hardness may be obtained, but viscosity may increase.

The urethane (meth)acrylate oligomer which is well-known in the related field may be used herein without limitation. Preferably, the urethane (meth)acrylate oligomer prepared by reacting a compound having at least one isocyanate group in its molecule with a (meth)acrylate compound having at least one hydroxyl group in its molecule may be used.

A specific example of the compound having at least one isocyanate group in its molecule includes at least one selected from the group consisting of 4,4′-dicyclohexyl diisocyanate, hexamethylene diisocyanate trimer, 1,4-diisocyanato butane, 1,6-diisocyanato hexane, 1,8-diisocyanato octane, 1,12-diisocyanato decane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylene-bis(2,6-dimethyl-phenyl isocyanate), 4,4′-oxybis(phenyl isocyanate), trifunctional isocyanate derived from hexamethylene diisocyanate, the adduct of toluene diisocyanate with trimethylolpropane, acryloyl ethyl isocyanate, methacryloyl ethyl isocyanate, trifunctional isocyanate derived from isophorone diisocyanate, and hexamethylene diisocyanate biuret.

A specific example of the (meth)acrylate compound having at least one hydroxyl group in its molecule include at least one selected from the group consisting of 2-hydroxyethyl(meth)acrylate, 2-hydroxy-isopropyl (meth)acrylate, 4-hydroxybutyl (meth)acrylate, caprolactone-modified hydroxy acrylate, a pentaerythritol tri/tetra(meth)acrylate mixture, and a dipentaerythritol penta/hexa (meth)acrylate mixture.

The molecular weight of the acrylate oligomer according to the embodiment of the present invention is not particularly limited, and for example, may be in the range of 500 to 100,000. When the weight average molecular weight is less than 500, the effect of improving hardness is low, and when the weight average molecular weight is more than 100,000, viscosity may increase, and thus workability may decrease during coating.

The content of the acrylate oligomer according to the embodiment of the present invention is not particularly limited, and for example, may be included at 5 to 70 wt % based on the total weight of the composition. When the content of the acrylate oligomer is less than 5 wt %, the effect of improving cracking and bending deformation due to shrinkage generated during curing is low, and when the content of the acrylate oligomer is more than 70 wt %, the effect of improving hardness may be inhibited.

The composition for forming a hard coating layer according to the embodiment of the present invention may further include a reactive monomer having a functional group which is crosslinklable with the above-described epoxy siloxane resin to enhance flexibility.

The reactive monomer according to the embodiment of the present invention is not particularly limited, and an acrylic monomer which is usually used in the related field may be used. Preferably, a polyfunctional (meth)acrylate monomer may be used to improve a surface hardness.

Specific examples of the reactive monomer include 2-ethylhexyl acrylate, octadecyl acrylate, isodecyl acrylate, 2-phenoxyethyl acrylate, lauryl acrylate, stearyl acrylate, behenyl acrylate, tridecyl methacrylate, nonylphenol ethoxylate monoacrylate, β-carboxyethyl acrylate, isobornyl acrylate, tetrahydrofurfuryl acrylate, tetrahydrofurfuryl methacrylate, 4-butyl-cyclohexyl acrylate, dicyclopentenyl acrylate, dicyclopentenyl oxyethyl acrylate, ethoxyethoxy ethyl acrylate, ethoxylated monoacrylate, 1,6-hexanediol diacrylate, triphenyl glycol diacrylate, butanediol diacrylate, 1,3-butylene glycol dimethacrylate, 1,6-hexanediol dimethacrylate, neopentyl glycol diacrylate, ethylene glycol dimethacrylate, diethylene glycol diacrylate, diethylene glycol dimethacrylate, tetraethylene glycol diacrylate, tetraethylene glycol dimethacrylate, triethylene glycol diacrylate, triethylene glycol dimethacrylate, polyethylene glycol diacrylate, polyethylene glycol dimethacrylate, dipropylene glycol diacrylate, ethoxylated neopentyl glycol diacrylate, trimethylolpropane triacrylate, trimethylolpropane trimethacrylate, pentaerythritol triacrylate, pentaerythritol trimethacrylate, pentaerythritol tetramethacrylate, pentaerythritol tetraacrylate, ethoxylated triacrylate, tris(2-hydroxyethyl) isocyanurate triacrylate, dipentaerythritol pentaacrylate, ditrimethylolpropane tetraacrylate, alkoxylated tetraacrylate, or the like, and preferably, pentaerythritol triacrylate, pentaerythritol trimethacrylate, pentaerythritol tetramethacrylate, pentaerythritol tetraacrylate, etc. One or mixtures of two or more types thereof may be used.

The content of the reactive monomer according to the embodiment of the present invention is not particularly limited, and for example, may be included at 1 to 70 wt % based on the total weight of the composition. When the content of the reactive monomer is less than 1 wt % or more than 70 wt %, it is difficult to obtain a sufficient effect of improving flexibility.

The composition for forming a hard coating layer according to the embodiment of the present invention further includes a polymerization initiator.

Examples of the polymerization initiator include a photo-radical polymerization initiator, a photo-cationic polymerization initiator, a thermal polymerization initiator or the like which are usually used. One or mixtures of two or more types thereof may be used.

Examples of the photo-radical polymerization initiator include 1-hydroxycyclohexyl phenyl ketone, 2,2-dimethoxy-2-phenyl acetophenone, xanthone, fluorene, fluorenone, benzaldehyde, anthraquinone, triphenylamine, carbazole, 3-methyl-acetophenone, 4-chloro-benzophenone, 4,4′-dimethoxy benzophenone, 4,4′-diamino benzophenone, Mihira ketone, benzoyl propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethyl thioxanthone, 2-isopropyl thioxanthone, 2-chloro thioxanthone, 2-methyl-1-[4-(methylthio)phenyl]-2-morpholinopropan-1-one, 2,4,6-trimethylbenzoyl diphenylphosphine oxide, 2-benzyl-1-dimethylamino-1-(4-morpholinophenyl)butan-1-one, 1-[4-(2-hydroxyethoxy)-phenyl]-2-hydroxy-2-methylpropan-1-one, etc.

Examples of the photo-cationic polymerization initiator include an onium salt and/or an organometallic salt, or the like, but are not limited thereto. For example, a diaryl iodonium salt, a triaryl sulfonium salt, an aryl diazonium salt, an iron-arene complex or the like may be used.

More specifically, examples of the photo-cationic polymerization initiator include an aryl sulfonium hexafluoroantimonate salt, an aryl sulfonium hexafluorophosphate salt, a diphenyliodonium hexafluoroantimonate salt, a diphenyliodonium hexafluorophosphate salt, a ditolyliodonium hexafluorophosphate salt, a 9-(4-hydroxyethoxy phenyl)thianthrenium hexafluorophosphate salt, or the like, and the antimonate salt may cause an environmental issue, and thus hexafluorophosphate salt-based initiator may be preferably used. One or mixtures of two or more types thereof may be used.

Examples of the thermal polymerization initiator include a 3-methyl-2-butenyl tetramethylene sulfonium hexafluoroantimonate salt, an ytterbium trifluoromethenesulfonate salt, a samarium trifluoromethenesulfonate salt, an erbium trifluoromethenesulfonate salt, a dysprosium trifluoromethenesulfonate salt, a lanthanum trifluoromethenesulfonate salt, a tetrabutylphosphonium methenesulfonate salt, an ethyltriphenylphosphonium bromide salt, benzyl dimethyl amine, dimethyl aminomethylphenol, triethanolamine, N-n-butylimidazole, 2-ethyl-4-methylimidazole, etc. One or mixtures of two or more types thereof may be used.

The content of the polymerization initiator according to the embodiment of the present invention is not particularly limited, and for example, may be included at 0.1 to 10 parts by weight based on 100 parts by weight of the epoxy siloxane resin. When the content of the polymerization initiator is in the above-described range, an excellent curing efficiency of the composition may be maintained, and the degradation of physical properties due to remaining components after curing may be prevented.

As necessary, the composition for forming a hard coating layer according to the embodiment of the present invention may further include an antioxidant for inhibiting the oxidation reaction attributable to the polymerization initiator.

The antioxidant is not particularly limited, and examples of the antioxidant include a phenolic antioxidant, a phosphoric antioxidant, an aminic antioxidant, a thioester antioxidant, etc.

Specific examples of the phenolic antioxidant include tetrakis[methylene-3-(3,5-di-tert-butyl-4-hydroxyphenyl)propionate]methane, 1,2-bis(3,5-di-tert-butyl-4-hydroxyhydrocinnamoyl)hydrazine, thiodiethylene bis[3-(3,5-di-tert-butyl-4-hydroxyphenyl)propionate], octadecyl-3-(3,5-di-tert-butyl-4-hydroxyphenyl)propionate, isotridecyl-3-(3,5-di-tert-butyl-4-hydroxyphenyl)propionate, N,N′-hexamethylenebis(3,5-di-tert-butyl-4-hydroxyhydrocinnamamide), benzenepropanoic acid, 3,5-Bis(1,1-dimethylethyl)-4-hydroxybenzenepropanoic acid thiodi-2,1-ethanediyl ester, C7-9-branched alkyl ester, 2,2′-ethylidene bis(4,6-di-tert-butylphenol), 1,3,5-trimethyl-2,4,6-tris(3,5-di-tert-butyl-4-hydroxybenzyl)benzene, 4,6-bis(octylthiomethyl)-o-cresol, 1,3,5-tris(2,6-dimethyl-3-hydroxy-4-tert-butylbenzyl)isocyanurate, 2,2′-methylenebis(4-methyl-6-tert-butylphenol), triethylene glycol-bis-3-(3-tert-butyl-4-hydroxy-5-methylphenyl)propionate, 2,5-di-tert-amyl-hydroquinone, hexamethylenebis[3-(3,5-di-tert-butyl-4-hydroxyphenyl)propionate], tris-(3,5-di-tert-butylhydroxybenzyl)isocyanurate, 4,4′-thiobis(6-tert-butyl-m-cresol), 4,4′-butylidene bis(6-tert-3-methylphenol), etc.

Specific examples of the phosphoric antioxidant include tris(2,4-di-tert-butylphenyl)nonyl, di stearyl pentaerythritol dinonyl, bis(2,4-di-tert-butylphenyl)pentaerythritol dinonyl, triphenyl nonyl, triisodecyl nonyl, diphenylisodecyl nonyl, 2-ethylhexyl diphenyl nonyl, poly(dipropylene glycol)phenyl nonyl, tris(nonylphenyl)nonyl, etc.

A specific example of the aminic antioxidant includes 2,2,4-trimethyl-1,2-dihydroquinoline oligomer, and specific examples of the thioester antioxidant include pentaerythrityl tetrakis(3-laurylthiopropionate), di stearyl thiodipropionate, dilauryl thiodipropionate, ditridecyl thiodipropionate, etc.

The content of the antioxidant according to the embodiment of the present invention is not particularly limited. For example, the antioxidant may be included at 0.1 to 10 parts by weight, preferably 1 to 8 parts by weight, and more preferably 3 to 6 parts by weight based on 100 parts by weight of the epoxy siloxane resin. When the content of the antioxidant is less than 0.1 part by weight, the effect of anti-oxidation is low, and thus thermal resistance may decrease. When the content of the antioxidant is more than 10 parts by weight, thermal resistance may also decrease due to the self-oxidation of the antioxidant.

The composition for forming a hard coating layer according to the embodiment of the present invention further includes a solvent.

The solvent according to the embodiment of the present invention is not particularly limited and a solvent known in the related field may be used. Examples of the solvent include alcohols such as methanol, ethanol, isopropanol, butanol, methyl cellosolve, ethyl cellosolve or the like, ketones such as methyl ethyl ketone, methyl butyl ketone, methyl isobutyl ketone, diethyl ketone, dipropyl ketone, cyclohexanone or the like, hexanes such as hexane, heptane, octane, or the like, benzenes such as benzene, toluene, xylene, etc. One or mixtures of two or more types thereof may be used.

The content of the solvent according to the embodiment of the present invention is not particularly limited, and for example, may be included at 20 to 70 parts by weight based on 100 parts by weight of the epoxy siloxane resin. When the content of the solvent is less than 20 parts by weight, viscosity is too high, and thus workability may decrease. When the content of the solvent is more than 70 parts by weight, the thickness of a coating layer is difficult to be adjusted during the coating process for a thick film, the drying time of the solvent is also extended after the coating process, and thus the process speed may decrease, resulting in low economic efficiency.

As necessary, the composition for forming a hard coating layer according to the embodiment of the present invention may further include an inorganic filler to improve hardness.

The inorganic filler is not particularly limited, and examples of the inorganic filler include metal oxides such as silica, alumina, titanium oxide or the like; hydroxides such as aluminum hydroxide, magnesium hydroxide, potassium hydroxide or the like; metal particles such as gold, silver, copper, nickel, alloys thereof or the like; conductive particles such as carbon, carbon nanotube, fullerene or the like; glass; ceramic or the like, and preferably, the inorganic filler may be silica. One or mixtures of two or more types thereof may be used.

The diameter of the inorganic filler is not particularly limited, and for example, may be in the range of 1 to 100 nm. When the average diameter is less than 1 nm, the effect of improving hardness is low, and when the average diameter is more than 100 nm, the inorganic filler may function as a foreign matter of the hard coating layer. Preferably, the average diameter may be in the range of 10 to 30 nm.

The content of the inorganic filler according to the embodiment of the present invention is not particularly limited, and for example, may be included at 0.1 to 5 parts by weight based on 100 parts by weight of the epoxy siloxane resin. When the content of the inorganic filler is less than 0.1 part by weight, the effect of improving hardness is low, and when the content of the inorganic filler is more than 5 parts by weight, the viscosity may increase, and thus coatability may decrease.

As necessary, the composition for forming a hard coating layer according to the embodiment of the present invention may further include a lubricant to improve winding efficiency, blocking resistance, abrasion resistance and scratch resistance.

The type of the lubricant according to the embodiment of the present invention is not particularly limited, and examples of the lubricant include waxes such as a polyethylene wax, a paraffin wax, a synthetic wax, a montan wax or the like; synthetic resins such as a silicone-based resin, a fluorine-based resin, etc. One or mixtures of two or more types thereof may be used.

The content of the lubricant according to the embodiment of the present invention is not particularly limited, and for example, may be included at 0.1 to 5 parts by weight based on 100 parts by weight of the epoxy siloxane resin. When the content of the lubricant is in the above-described range, excellent blocking resistance, abrasion resistance and scratch resistance may be provided, and satisfactory transparency may also be maintained.

In addition, additives such as antioxidants, UV absorbers, light stabilizers, thermal polymerization inhibitors, leveling agents, surfactants, lubricants, antifouling agents or the like may be further included as necessary.

Hard Coating Film

Further, the present invention provides a hard coating film 100 including a base material 110 of which at least one surface has a hard coating layer 120 formed of the composition for forming a hard coating layer.

Preferably, the base material 110 according to the embodiment of the present invention has excellent transparency, mechanical strength, thermal stability, water blocking properties, isotropy, etc. Examples of the base material 110 include base materials made from polyester resins such as polyethylene terephthalate, polyethylene isophthalate, polybutylene terephthalate or the like; cellulose resins such as diacetyl cellulose, triacetyl cellulose or the like; polycarbonate resins; acrylic resins such as polymethyl (meth)acrylate, polyethyl (meth)acrylate or the like; styrene resins such as polystyrene, an acrylonitrile-styrene copolymer or the like; polyolefin resins such as polyethylene, polypropylene, a polyolefin-based resin having a cyclo or norbornene structure, an ethylene-propylene copolymer or the like; polyimide resins; polyether sulfone resins; sulfone resins, etc. One or mixtures of two or more types thereof may be used.

The thickness of the base material 110 is not particularly limited, and for example, may be in the range of 20 to 150 μm.

The hard coating layer 120 is formed by coating with the composition for forming a hard coating layer and curing, and coating may be performed using well-known methods such as a die coater method, an air knife method, a reverse roll method, a spraying method, a blade method, a casting method, a gravure method, a spin coating method, etc.

The thickness of the hard coating layer 120 is not particularly limited, and for example, may be in the range of 30 to 100 μm. When the thickness of the hard coating layer 120 is in the above-described range, a curling phenomenon hardly occurs, and the hard coating layer 120 having excellent hardness may be obtained.

The hard coating layer 120 according to the embodiment of the present invention is formed of the composition for forming a hard coating layer, and thus has significantly improved hardness. Although hardness may vary depending on the content, type or the like of each composition, the pencil hardness of the hard coating layer 120 may be 5H or more, and when each of the above-described composition is mixed at a desired content, the maximum pencil hardness of the hard coating layer 120 may be 9H or more.

Moreover, flexibility is notably enhanced, and thus bending deformation is small.

The hard coating film 100 has high surface hardness, includes the hard coating layer 120 having excellent flexibility, and thus is lighter and has excellent impact resistance as compared to tempered glass. Accordingly, the hard coating film 100 may be preferably used as a window substrate at the outermost surface of the display panel.

Furthermore, the present invention provides an image display device including the hard coating film 100.

The hard coating film 100 may be used as a window substrate at the outermost surface of the image display device, and the image display device may include various image display devices which are usually used, such as a liquid crystal display device, an electroluminescence display device, a plasma display device, a field emission display device, etc.

Hereinafter, the present invention will be described in detail in conjunction with examples.

### Preparation Example 1

2-(3,4-epoxycyclohexyl)ethyltrimethoxysilane (ECTMS, manufactured by Tokyo Chemical Industry Co., Ltd.) and water (H₂O, manufactured by Sigma-Aldrich Corporation) were mixed at a ratio of 24.64 g:2.70 g (0.1 mol:0.15 mol), and then put into a 250 ml 2-neck flask. Thereafter, 0.1 ml of tetramethyl ammonium hydroxide as a catalyst and 100 mL of methyl ethyl ketone (MEK) were added to the mixture, and stirred at 60° C. for 36 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 2

2-(3,4-epoxycyclohexyl)ethyltrimethoxysilane (ECTMS, manufactured by Tokyo Chemical Industry Co., Ltd.) and water (H₂O, manufactured by Sigma-Aldrich Corporation) were mixed at a ratio of 24.64 g:2.70 g (0.1 mol:0.15 mol), and then put into a 250 ml 2-neck flask. Thereafter, 0.1 ml of tetramethyl ammonium hydroxide as a catalyst and 50 mL of MEK were added to the mixture, and stirred at 70° C. for 24 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 3

2-(3,4-epoxycyclohexyl)ethyltrimethoxysilane (ECTMS, manufactured by Tokyo Chemical Industry Co., Ltd.), phenyl trimethoxysilane (PTMS, manufactured by Sigma-Aldrich Corporation) and water (H₂O, manufactured by Sigma-Aldrich Corporation) were mixed at a ratio of 12.32 g:12.02 g:2.70 g (0.05 mol:0.05 mol:0.15 mol), and then put into a 250 ml 2-neck flask. Thereafter, 0.1 ml of tetramethyl ammonium hydroxide as a catalyst and 50 mL of MEK were added to the mixture, and stirred at 80° C. for 24 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 4

2-(3,4-epoxycyclohexyl)ethyltrimethoxysilane (ECTMS, manufactured by Tokyo Chemical Industry Co., Ltd.), and water (H₂O, manufactured by Sigma-Aldrich Corporation) were mixed at a ratio of 24.64 g:2.70 g (0.1 mol:0.15 mol), and then put into a 100 ml 2-neck flask. Thereafter, 0.1 ml of tetramethyl ammonium hydroxide as a catalyst was added to the mixture, and stirred at 60° C. for 24 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 5

2-(3,4-epoxycyclohexyl)ethyltrimethoxysilane (ECTMS, manufactured by Tokyo Chemical Industry Co., Ltd.), and water (H₂O, manufactured by Sigma-Aldrich Corporation) were mixed at a ratio of 24.64 g:2.70 g (0.1 mol: 0.15 mol), and then put into a 100 ml 2-neck flask. Thereafter, 0.1 ml of tetramethyl ammonium hydroxide as a catalyst was added to the mixture, and stirred at 80° C. for 24 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 6

3-glycidoxypropyltrimethoxysilane (GPTS, manufactured by Sigma-Aldrich Corporation) and distilled water were mixed at a ratio of 23.63 g:2.70 g (1 mol: 1.5 mol), and 0.02 g of sodium hydroxide as a catalyst for promoting the reaction was added to the mixture, and stirred at 80° C. for 24 hours. Then, propylene glycol methyl ether acetate (PGMEA, manufactured by Sigma-Aldrich Corporation) was added to the mixture, the mixture was reacted with a volatile material at 0.1 MPa and 60° C. for 30 minutes using a vacuum evaporator, water remaining in the resin was removed, and thereby the resin was obtained.

### Preparation Example 7

2-(3,4-epoxycyclohexyl)ethyltrimethoxysilane (ECTMS, manufactured by Tokyo Chemical Industry Co., Ltd.), and water (H₂O, manufactured by Sigma-Aldrich Corporation) were mixed at a ratio of 24.64 g:2.70 g (0.1 mol: 0.15 mol), and then put into a 100 ml 2-neck flask. Thereafter, 0.05 ml of tetramethyl ammonium hydroxide as a catalyst and 50 mL of MEK were added to the mixture, and stirred at 70° C. for 36 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 8

2-(3,4-epoxycyclohexyl)ethyltrimethoxysilane (ECTMS, manufactured by Tokyo Chemical Industry Co., Ltd.), and water (H₂O, manufactured by Sigma-Aldrich Corporation) were mixed at a ratio of 24.64 g:2.70 g (0.1 mol: 0.15 mol), and then put into a 100 ml 2-neck flask. Thereafter, 0.5 ml of tetramethyl ammonium hydroxide as a catalyst and 50 mL of MEK were added to the mixture, and stirred at 70° C. for 24 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 9

2-(3,4-epoxycyclohexyl)ethyltrimethoxysilane (ECTMS, manufactured by Tokyo Chemical Industry Co., Ltd.), phenyl trimethoxysilane (PTMS, manufactured by Sigma-Aldrich Corporation) and water (H₂O, manufactured by Sigma-Aldrich Corporation) were mixed at a ratio of 11.09 g:13.22 g:2.70 g (0.045 mol:0.055 mol:0.15 mol), and then put into a 250 ml 2-neck flask. Thereafter, 0.1 ml of tetramethyl ammonium hydroxide as a catalyst and 50 mL of MEK were added to the mixture, and stirred at 80° C. for 24 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 10

2-(3,4-epoxycyclohexyl)ethyltrimethoxysilane (ECTMS, manufactured by Tokyo Chemical Industry Co., Ltd.), and water (H₂O, manufactured by Sigma-Aldrich Corporation) were mixed at a ratio of 24.64 g:2.70 g (0.1 mol:0.15 mol), and then put into a 100 ml 2-neck flask. Thereafter, 0.1 ml of tetramethyl ammonium hydroxide as a catalyst and 100 mL of MEK were added to the mixture, and stirred at 60° C. for 36 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 11

2-(3,4-epoxycyclohexyl)ethyltrimethoxysilane (ECTMS, manufactured by Tokyo Chemical Industry Co., Ltd.), and water (H₂O, manufactured by Sigma-Aldrich Corporation) were mixed at a ratio of 24.64 g:2.70 g (0.1 mol:0.15 mol), and then put into a 100 ml 2-neck flask. Thereafter, 1.0 ml of tetramethyl ammonium hydroxide as a catalyst was added to the mixture, and stirred at 80° C. for 48 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 12

2-(3,4-epoxycyclohexyl)ethyltrimethoxysilane (ECTMS, manufactured by Tokyo Chemical Industry Co., Ltd.), and water (H₂O, manufactured by Sigma-Aldrich Corporation) were mixed at a ratio of 24.64 g:2.70 g (0.1 mol:0.15 mol), and then put into a 100 ml 2-neck flask. Thereafter, 0.5 ml of tetramethyl ammonium hydroxide as a catalyst was added to the mixture, and stirred at 80° C. for 36 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 13

2-(3,4-epoxycyclohexyl)ethyltrimethoxysilane (ECTMS, manufactured by Tokyo Chemical Industry Co., Ltd.), and water (H₂O, manufactured by Sigma-Aldrich Corporation) were mixed at a ratio of 24.64 g:2.70 g (0.1 mol: 0.15 mol), and then put into a 100 ml 2-neck flask. Thereafter, 1.0 ml of tetramethyl ammonium hydroxide as a catalyst was added to the mixture, and stirred at 70° C. for 36 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

### Preparation Example 14

2-(3,4-epoxycyclohexyl)ethyltrimethoxysilane (ECTMS, manufactured by Tokyo Chemical Industry Co., Ltd.), and water (H₂O, manufactured by Sigma-Aldrich Corporation) were mixed at a ratio of 24.64 g:2.70 g (0.1 mol:0.15 mol), and then put into a 100 ml 2-neck flask. Thereafter, 0.2 ml of tetramethyl ammonium hydroxide as a catalyst and 50 mL of MEK were added to the mixture, and stirred at 60° C. for 36 hours. Then, the mixture was filtered using a 0.45 μm Teflon filter, and thereby an alicyclic epoxy siloxane resin was obtained. The molecular weight of the alicyclic epoxy siloxane resin was measured using gel permeation chromatography (GPC).

TABLE 1

| | | | | Epoxy |
|---|---|---|---|---|
| | | | PDI | equivalent weight |
| Classification | Mn | Mw | (Mw/Mn) | (mmol/g) |
| Preparation | 650 | 1980 | 3.05 | 6.3 |
| Example 1 | | | | |
| Preparation | 2300 | 5500 | 2.39 | 6.3 |
| Example 2 | | | | |
| Preparation | 1655 | 5100 | 3.08 | 3.15 |
| Example 3 | | | | |
| Preparation | 3029 | 8016 | 2.65 | 6.3 |
| Example 4 | | | | |
| Preparation | 3645 | 11745 | 3.22 | 6.3 |
| Example 5 | | | | |
| Preparation | 2040 | 5100 | 2.50 | 6.3 |
| Example 6 | | | | |
| Preparation | 2804 | 5206 | 1.86 | 6.3 |
| Example 7 | | | | |
| Preparation | 1210 | 5320 | 4.40 | 6.3 |
| Example 8 | | | | |
| Preparation | 1700 | 5000 | 2.94 | 2.84 |
| Example 9 | | | | |
| Preparation | 972 | 2430 | 2.50 | 6.3 |
| Example 10 | | | | |
| Preparation | 3980 | 15500 | 3.89 | 6.3 |
| Example 11 | | | | |
| Preparation | 2590 | 10500 | 4.05 | 6.3 |
| Example 12 | | | | |
| Preparation | 4210 | 8700 | 2.07 | 6.3 |
| Example 13 | | | | |
| Preparation | 1740 | 6800 | 3.91 | 6.3 |
| Example 14 | | | | |

### Examples and Comparative Examples

The compositions for forming a hard coating layer which have compositions and contents listed in the following Table 2 were prepared.

TABLE 2

| | Siloxane resin | | | | | |
|---|---|---|---|---|---|---|
| | | Parts by | Initiator | | | Solvent |
| Classification | Component | weight | AP | HP | IP | MEK |
| Comparative | Preparation | 100 | 4 | — | — | 40 |
| Example 1 | Example 1 | | | | | |
| Comparative | Preparation | 100 | — | 4 | — | 40 |
| Example 2 | Example 1 | | | | | |
| Comparative | Preparation | 100 | — | — | 4 | 40 |
| Example 3 | Example 1 | | | | | |
| Comparative | Preparation | 100 | — | 4 | — | 40 |
| Example 4 | Example 7 | | | | | |
| Comparative | Preparation | 100 | — | 4 | — | 40 |
| Example 5 | Example 8 | | | | | |
| Comparative | Preparation | 100 | — | 4 | — | 40 |
| Example 6 | Example 11 | | | | | |
| Comparative | Preparation | 100 | — | 4 | — | 40 |
| Example 7 | Example 12 | | | | | |
| Example 1 | Preparation | 100 | — | 4 | — | 40 |
| | Example 2 | | | | | |
| Example 2 | Preparation | 100 | — | 4 | — | 40 |
| | Example 3 | | | | | |
| Example 3 | Preparation | 100 | — | 4 | — | 40 |
| | Example 4 | | | | | |
| Example 4 | Preparation | 100 | — | 4 | — | 40 |
| | Example 5 | | | | | |
| Example 5 | Preparation | 100 | — | 4 | — | 40 |
| | Example 6 | | | | | |
| Example 6 | Preparation | 100 | — | 4 | — | 40 |
| | Example 9 | | | | | |
| Example 7 | Preparation | 100 | — | 4 | — | 40 |
| | Example 10 | | | | | |
| Example 8 | Preparation | 100 | — | 4 | — | 40 |
| | Example 13 | | | | | |
| Example 9 | Preparation | 100 | — | 4 | — | 40 |
| | Example 14 | | | | | |

AP: aryl sulfonium hexafluoroantimonate salt
HP: aryl sulfonium hexafluorophosphate salt
IP: diphenyliodonium hexafluorophosphate salt
MEK: methyl ethyl ketone

### Experimental Example

(1) Measurement of Pencil Hardness

The compositions for forming a hard coating layer prepared in the examples and comparative examples were applied onto a base material which is polyethylene terephthalate having a thickness of 188 μm, were cured under conditions of 300 mW/cm and 1.2 J/cm² using a metal halide lamp having a wavelength of 365 nm, and thereby a hard coating layer having a thickness of 50 μm was formed. The obtained hard coating layer was laid in an oven of 130° C. for 30 minutes for post curing, and thereby a final product was obtained.

The hardness of the hard coating layer was measured using a pencil hardness tester according to JIS K5600.

(2) Evaluation of Flexibility

The base material prepared in Experimental Example 1 was wound at an angle of 180° on a cylinder having a bottom radius R₁ in a manner in which the hard coating layer was positioned at an inner side, and went back to the original position. Thereafter, the minimum R₁ of the cylinder in which the bending deformation such as a trace of fold, stains, whitening, cracks or the like of the hard coating layer was not observed was reported.

Further, the base material was wound at an angle of 180° on a cylinder having a bottom radius R₂ in a manner in which the hard coating layer was positioned at an outer side, and went back to the original position. Thereafter, the minimum R₂ of the cylinder in which the bending deformation of the hard coating layer was not observed was reported.

TABLE 3

Flexibility (mm)

| Classification | Pencil hardness | R¹ | R² |
|---|---|---|---|
| Comparative | 4H | 7 | 30 |
| Example 1 | | | |
| Comparative | 3H | 5 | 30 |
| Example 2 | | | |
| Comparative | 2H | 5 | 20 |
| Example 3 | | | |
| Comparative | 4H | 5 | 30 |
| Example 4 | | | |
| Comparative | 3H | 5 | 30 |
| Example 5 | | | |
| Comparative | — | — | — |
| Example 6 | | | |
| Comparative | 6H | 8 | 45 |
| Example 7 | | | |
| Example 1 | 8H | 5 | 20 |
| Example 2 | 7H | 5 | 20 |
| Example 3 | 9H | 5 | 25 |
| Example 4 | 9H | 5 | 25 |
| Example 5 | 6H | 5 | 20 |
| Example 6 | 7H | 5 | 20 |
| Example 7 | 6H | 3 | 10 |
| Example 8 | 8H | 5 | 20 |
| Example 9 | 9H | 5 | 15 |

Referring to Table 3, the hard coating layers made from the compositions of Examples 1 to 9 have high pencil hardness. Further, it was determined that the hard coating layers have low R¹ and R² values, that is, the hard coating layers have excellent flexibility.

However, the hard coating layers made from the compositions of Comparative Examples 1 to 5 and 7 have significantly low pencil hardness or reduced flexibility. Moreover, the composition of Comparative Example 6 was gelated, and thus no film could be prepared.

The composition according to the embodiment of the present invention can form a hard coating layer having significantly improved hardness.

The composition according to the embodiment of the present invention can form a hard coating layer having excellent flexibility such that bending deformation is minimized. Accordingly, the base material including the hard coating layer according to the embodiment of the present invention can ensure excellent flexibility without a separate bending deformation-suppressing layer.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A hard coating layer obtained by curing a composition comprising an epoxy siloxane resin,
wherein the epoxy siloxane resin has a weight average molecular weight in a range of 2,000 to 15,000, a polydispersity index (PDI) in a range of 2.0 to 4.0, and an epoxy equivalent weight in a range of 3.0 to 6.3 mmol/g.

2. The hard coating layer of claim 1, wherein the siloxane resin has a weight average molecular weight in a range of 5,000 to 15,000.

3. The hard coating layer of claim 1, wherein the siloxane resin is prepared by a hydrolysis and condensation reaction of an alkoxysilane represented by the following Formula 1:
R¹ₙSi(OR²)₄₋ₙ [Formula 1]
wherein R¹ is an epoxy cycloalkyl group having 3 to 6 carbon atoms, or a linear or branched alkyl group having 1 to 6 carbon atoms and substituted with an oxiranyl group, and R¹ interrupted by oxygen, R² is a linear or branched alkyl group having 1 to 7 carbon atoms, and n is an integer in a range of 1 to 3.

4. The hard coating layer of claim 3, wherein the alkoxysilane represented by Formula 1 is at least one selected from the group consisting of 2-(3,4-epoxycyclohexyl)ethyltrimethoxysilane, 2-(3,4-epoxycyclohexyl)ethyltriethoxysilane and 3-glycidoxypropyltrimethoxysilane.

5. The hard coating layer of claim 3, wherein the siloxane resin is prepared by a hydrolysis and condensation reaction of the alkoxysilane represented by Formula 1 and an alkoxysilane represented by the following Formula 2:
R³ₘSi(OR⁴)₄₋ₘ [Formula 2]
wherein, R³ includes at least one functional group selected from the group consisting of an alkyl group having 1 to 20 carbon atoms, a cycloalkyl group having 3 to 8 carbon atoms, an alkenyl group having 3 to 20 carbon atoms, an alkynyl group having 2 to 20 carbon atoms, and an aryl group having 6 to 20 carbon atoms, acrylic group, methacrylic group, halogen group, amino group, mercapto group, ether group, ester group, carbonyl group, carboxyl group, vinyl group, nitro group, sulfone group and alkyd group, R⁴ is a linear or branched alkyl group having 1 to 7 carbon atoms, and m is an integer in a range of 0 to 3.

6. The hard coating layer of claim 2, wherein the composition further comprises a polymerization initiator at 0.1 to 10 parts by weight and a solvent at 20 to 70 parts by weight based on 100 parts by weight of the epoxy siloxane resin.

7. The hard coating layer of claim 1, wherein the composition further comprises a reactive monomer having a functional group which is crosslinkable with the epoxy siloxane resin,
wherein the reactive monomer includes at least one of an acrylic monomer or a polyfunctional (meth)acrylate monomer.

8. The hard coating layer of claim 8, wherein the reactive monomer is from 1 to 70 wt % of the total weight of the composition.

9. The hard coating layer of claim 7, wherein the composition further comprises an antioxidant and an inorganic filler, the inorganic filler having an average diameter in the range of from 10 to 30 nm.

10. The hard coating layer of claim 9, wherein the antioxidant is included in an amount of 0.1 to 10 parts by weight based on 100 parts by weight of the epoxy siloxane resin.

11. The hard coating layer of claim 9, wherein the inorganic filler is included in an amount of 0.1 to 5 parts by weight based on 100 parts by weight of the epoxy siloxane resin.

12. The hard coating layer of claim 7, wherein the composition further comprises a lubricant in an amount of from 0.1 to 5 parts by weight based on 100 parts by weight of the epoxy siloxane resin.

13. The hard coating layer of claim 7, wherein the composition further comprises an acrylate oligomer.

14. The hard coating layer of claim 13, wherein the acrylate oligomer is a urethane acrylate oligomer having a molecular weight in the range of 500 to 100,000.

15. The hard coating layer of claim 1, wherein a pencil hardness of the hard coating layer is 5H or more.

16. The hard coating layer of claim 1, wherein a pencil hardness of the hard coating layer is 9H or more.

17. A hard coating film, comprising a base material of which at least one surface has the hard coating layer of claim 1, wherein the base material is made from at least one resin selected from the group consisting of a polyester-based resin, a cellulose-based resin, a polycarbonate-based resin, an acrylic resin, a styrene-based resin, a polyolefin-based resin, a polyimide-based resin, a polyether sulfone-based resin and a sulfone-based resin,

18. The hard coating film of claim 17, wherein the hard coating layer has bending radius values R¹ and R² in the range of 3 to 5 mm, and 10 to 20 mm, respectively.
wherein R¹ is a bending radius measured by positioning the hard coating layer at an inner side, and R² is a bending radius measured by positioning the hard coating layer at an outer side.

19. The hard coating film of claim 18, wherein the epoxy siloxane resin is an alicyclic epoxy siloxane resin.

20. The hard coating film of claim 17, wherein the base material has a thickness in the range of 20 to 150 μm, and
wherein the hard coating layer has a thickness after curing in the range of 30 to 100 μm and a pencil hardness of 9H or more.
